(19) United States
(12) Patent Application Publication
(10) Pub. No.: US 2005/0283472 A1
(43) Pub. Date: Dec. 22, 2005

(54) Browsing apparatus and browsing method

(75) Inventors: Naoki Hayashi, Kanagawa (JP); Minoru Koshimizu, Kanagawa (JP); Yoshitsugu Hirose, Kanagawa (JP); Hiroyuki Hotta, Kanagawa (JP); Tsutomu Ishii, Kanagawa (JP); Yasunori Saito, Kanagawa (JP); Ikuiaroh Nagatsuka, Tokyo (JP); Eriko Tamaru, Kanagawa (JP); Kimitake Hasuike, Kanagawa (JP); Tsunemasa Mita, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/034,242

(22) Filed: Jan. 13, 2005

(30) Foreign Application Priority Data
Jun. 18, 2004 (JP) P2004-181077

(51) Int. Cl. G06F 17/30

(52) U.S. Cl. 707/4

(57) ABSTRACT

When one is selected from a plurality of channel and title display regions (channel cards) indicating titles displayed on a selection screen in a display screen of a display part, display contents of the channel card changes over to information such as a title, an summary and a date of issue while an article composed of a title, a text and images is displayed on a detailed screen.

### BACKGROUND OF THE INVENTION

1. Field of the Invention

The present invention relates to a browsing apparatus and a browsing method adapted for browsing subjects of retrieval such as electronic documents distributed from a distributor of the subjects of retrieval such as electronic documents. Particularly it relates to a browsing apparatus and a browsing method aimed at improving visibility of a browsing screen and handling property for browsing.

2. Description of the Related Art

Distribution of electronic documents through the Internet has become widespread in recent years. A large number of electronic documents are distributed from electronic document distributors called “Web sites” day by day.

A user has to use an electronic document browsing software (Internet browser) for connecting Web sites of the user's interest one by one and receiving electronic documents from the Web sites. For this reason, the user must repeat a troublesome operation every day regardless of whether new documents are present or not.

In order to lighten such a troublesome operation, an electronic document browsing software called “RSS (Resource Description Framework Site Summary) reader” has been developed and has become spread to users.

The RSS reader is a software for receiving a file structuralized by the title, summary, date of distribution, contents ID (URL) of an electronic document from a Web site and displaying and operating a Web site name, a title name, contents, etc.

FIGS. 27 and 28 show structures of display screens generated by the RSS reader. FIG. 27 is a view showing an example of the display screen based on a two-pane structure. FIG. 28 is a view showing another example of the display screen based on a three-pane structure.

The display screen 500 based on the two-pane structure shown in FIG. 27 includes a channel and title display region 510, and a contents display region 520. In the channel and title display region 510, a plurality of titles 512 are displayed in the form of a tree each channel 511. In the contents display region 520, contents made up of a text 521 and images 522 corresponding to one title (hatched in FIG. 27) 512 selected from the plurality of titles 512 displayed in the channel and title display region 510 are displayed.

The display screen 500 based on the three-pane structure shown in FIG. 28 includes a channel display region 530, a title display region 540, and a contents display region 520. In the channel display region 530, a plurality of channels 511 are displayed in the form of a tree each channel category. In the title display region 540, a plurality of titles 512 corresponding to one channel (hatched in FIG. 28) 511 selected from the plurality of channels 511 displayed in the channel display region 530 are displayed. In the contents display region 520, contents made up of a text 521 and an image 522 corresponding to one title (hatched in FIG. 28) 512 selected from the plurality of titles 512 displayed in the title display region 540 are displayed.

When the display screen generated by the RSS reader according to the conventional art is of the two-pane structure shown in FIG. 27, it is however difficult to select a title because the whole description of the title cannot be displayed. When the display screen generated by the RSS reader according to the conventional art is of the three-pane structure shown in FIG. 28, it is still difficult to select a title because the title is displayed in a narrow region hard to view though the whole description of the title can be displayed. Moreover, the contents display region is too narrow to view the contents. These problems arise particularly conspicuously when a user is inexperienced in a meticulous finger operation on a touch panel or a mouse as a way to input information into a personal computer.

### SUMMARY OF THE INVENTION

The present invention has been made in view of the above circumstances and provides a browsing apparatus and a browsing method aimed at improving visibility of a browsing screen and handling property for browsing.

According to an aspect of the invention, there is provided a browsing apparatus including: a screen part for displaying a plurality of card-like selection buttons indicating identification data for identifying subjects of retrieval; a selection receiving part for receiving a selection of one of the selection buttons; and a display control part for displaying one of the subjects of retrieval corresponding to the selected selection button in the screen part.

According to another aspect of the invention, there is provided a browsing method including the steps of: displaying a plurality of card-like selection buttons indicating identification data for identifying subjects of retrieval in a screen part; receiving a selection of one selection button from the plurality of selection buttons; and displaying one of subjects of retrieval corresponding to the selected selection button in the screen part.

According to the aspects of the invention, the data for identifying subjects of retrieval can be recognized easily because each selection button is shaped like a card. The subjects of retrieval include electronic documents, images such as photographs, image-containing electronic documents, etc. The identification data includes graphics, symbols, images etc. besides characters such as titles, summaries, dates of distribution, etc. of electronic documents. The card shape includes a rectangular shape, a circular shape, an elliptic shape, a triangular shape, etc.

In the browsing apparatus and browsing method according to the invention, the data for identifying subjects of retrieval can be recognized easily because each selection button is shaped like a card. Accordingly, both visibility of a browsing screen and handling property for browsing can be improved.

### BRIEF DESCRIPTION OF THE DRAWING

Embodiments of the present invention will be described in detail based on the following figures, wherein:

FIG. 1 is a block diagram showing a browsing system according to a first embodiment of the invention;

FIG. 2 is a view showing an example of distribution site data according to the first embodiment of the invention;

FIG. 3 is a view showing an example of display on a display screen according to the first embodiment of the invention;

FIG. 4 is a view showing a received channel setting table in an electronic document display apparatus according to the first embodiment of the invention;

FIG. 5 is a view showing an article display history table in the electronic document display apparatus according to the first embodiment of the invention;

FIG. 6 is a view showing a channel table in the electronic document display apparatus according to the first embodiment of the invention;

FIG. 7 is a view showing a document table in the electronic document display apparatus according to the first embodiment of the invention;

FIG. 8 is a flow chart showing a display process on the electronic document display apparatus side according to the first embodiment of the invention;

FIG. 9 is a flow chart showing a user's procedure for operating the electronic document display apparatus according to the first embodiment of the invention;

FIG. 10 is a perspective view showing an electronic paper system according to a second embodiment of the invention;

FIG. 11 is a plan view showing a sheet of optically writable electronic paper according to the second embodiment of the invention;

FIG. 12 is a sectional view taken along the line A-A in FIG. 11;

FIG. 13A is a plan view showing a connector according to the second embodiment of the invention, and FIG. 13B is a sectional view taken on the line B-B in FIG. 13A;

FIG. 14 is a block diagram showing a control system of the electronic paper system according to the second embodiment of the invention;

FIG. 15 is a plan view showing an example of display on a screen part according to the second embodiment of the invention;

FIG. 16 is a plan view showing an example of display on the screen part according to the second embodiment of the invention;

FIG. 17 is a plan view showing an example of display on the screen part according to the second embodiment of the invention;

FIG. 18 is a plan view showing an example of display on the screen part according to the second embodiment of the invention;

FIG. 19 is a flow chart showing an operation of the electronic paper system according to the second embodiment of the invention;

FIG. 20 is a sectional view showing a sheet of electronic paper according to a third embodiment of the invention;

FIG. 21 is a perspective view showing a control system of an electronic paper system according to a fourth embodiment of the invention;

FIG. 22 is a block diagram showing the control system of the electronic paper system according to the fourth embodiment of the invention;

FIG. 23 is a flow chart showing an operation of the electronic paper system according to the fourth embodiment of the invention;

FIGS. 24A to 24D are plan views showing use modes of the electronic paper system according to the fourth embodiment of the invention;

FIG. 25 is a perspective view showing an electronic paper system according to a sixth embodiment of the invention;

FIG. 26 is a perspective view showing an electronic paper system according to a seventh embodiment of the invention;

FIG. 27 is a view showing a display screen based on a two-pane structure according to a conventional art; and

FIG. 28 is a view showing a display screen based on a three-pane structure according to the conventional art.

### DETAILED DESCRIPTION OF THE INVENTION

### First Embodiment

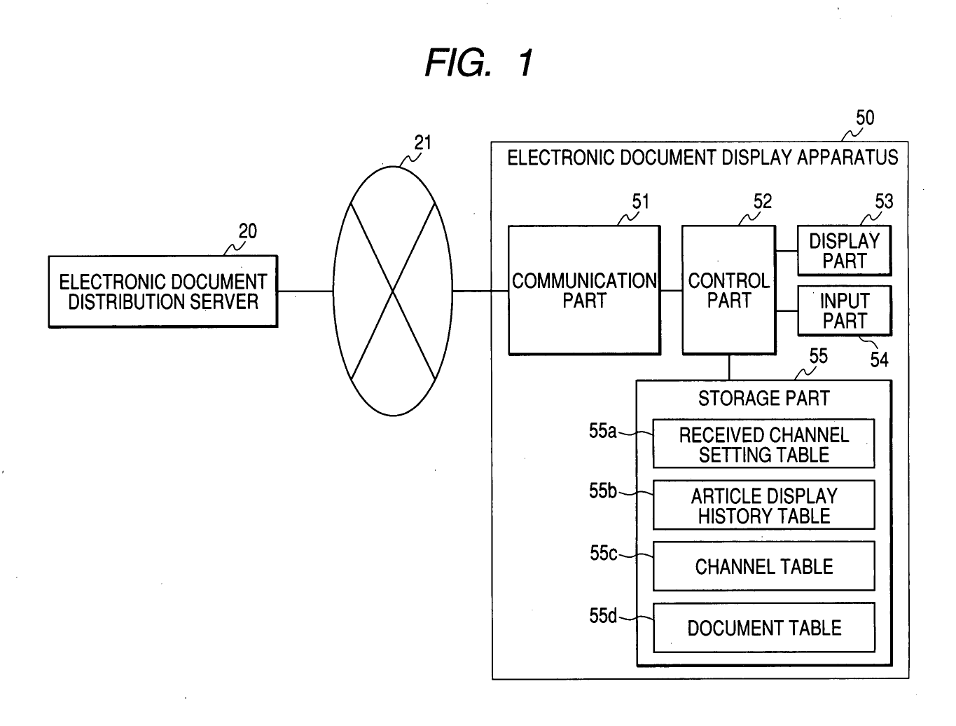

FIG. 1 is a block diagram showing a browsing system according to a first embodiment of the invention. The browsing system has an electronic document distribution server 20 for distributing electronic documents, a network 21 such as the Internet or an LAN (Local Area Network), and an electronic document display apparatus 50 connected to the electronic document distribution server 20 through the network 21 so as to serve as a browsing apparatus for acquiring and browsing electronic documents from the electronic document distribution server 20.

The electronic document display apparatus 50 includes: a communication part 51 for communicating with the electronic document distribution server 20 through the network 21; a control part 52 for controlling respective parts of the apparatus 50; a display part 53 such as an LCD (liquid crystal display); an input part 54 constituted by a keyboard, a mouse, and so on; and a storage part 55 for storing distribution site data distributed from the electronic document distribution server 20. For example, the electronic document display apparatus 50 can be implemented by a personal computer (PC).

The storage part 55 has: a received channel setting table 55a for storing channel IDs; an article display history table 55b for storing document IDs of displayed articles as history information; a channel table 55c for storing channel data such as channel titles, channel IDs, summaries, dates of display, and so on; and a document table 55d for storing document data such as channel titles, titles, document IDs, summaries, dates of issue, and so on.

Incidentally, as the input part 54, a touch panel such as a resistance film type (pressure sensing type) touch panel, an electromagnetic induction type touch panel, an electrostatic coupling type touch panel, a surface acoustic wave type touch panel or an infrared interruption type touch panel may be disposed in front of a screen of the display part 53. Thus, handling property for selection can be improved.

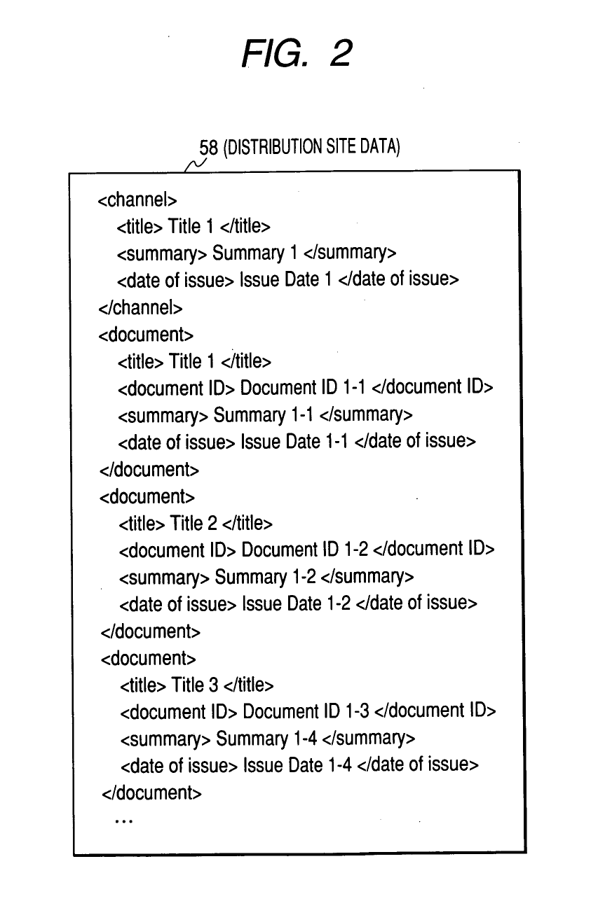

FIG. 2 shows an example of the distribution site data. The electronic document distribution server 20 distributes the distribution site data shown in FIG. 2 and electronic documents to the electronic document display apparatus 50 through the network 21 in response to a request from the electronic document display apparatus 50. The distribution site data include titles and summaries of the electronic documents, the dates of issue (the dates of distribution), document IDs, and so on.

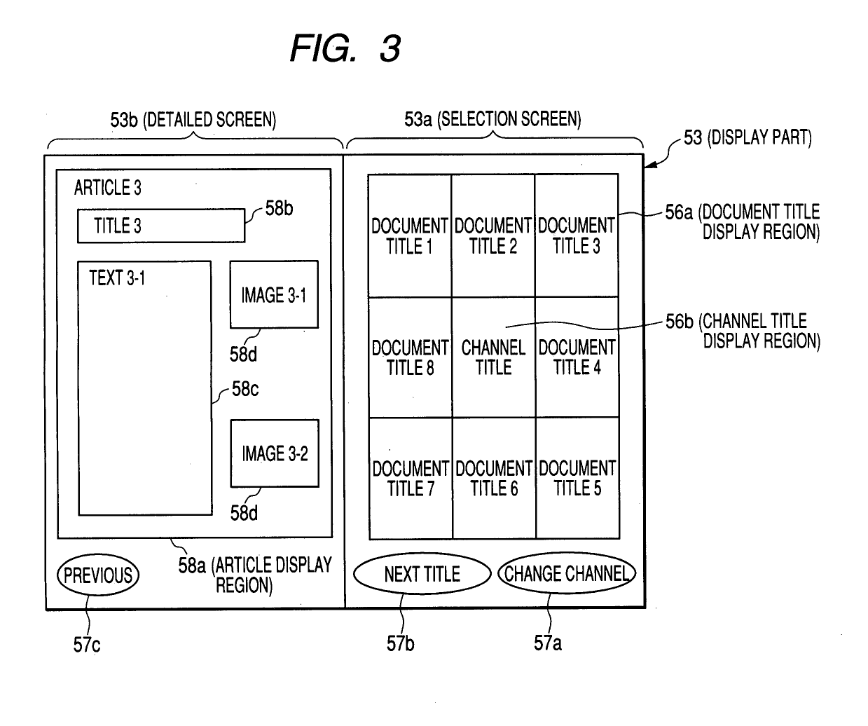

FIG. 3 shows an example of display on a display screen of the display part 53. A selection screen 53a is displayed on the right side of the display screen while a detailed screen 53b is displayed on the left side of the display screen. A channel title display region (channel card) 56b for displaying a channel name is disposed in the center of the selection screen 53a. Document title display regions (title cards) 56a serving as selection buttons for displaying the whole descriptions of titles are disposed in the form of a lattice around the channel title display region 56b. In other words, the selection screen 53a has a rectangular block having substantially equal-sized rectangular buttons within the rectangular block. One of the rectangular buttons, which is disposed at a center of these, is the channel title display region 56b and the other rectangular buttons are the document title display regions 56a. In the embodiment, these buttons are equal-sized rectangular buttons, however, these buttons are not necessarily equal-sized and rectangular. A “Channel Change” button 57a and a “Next Title” button 57b are displayed on the lower side of the selection screen 53a. An article display region 58a including a title 58b, a text 58c and images 58d is disposed on the detailed screen 53b. A “Previous” button 57c is displayed below the article display region 58a.

When one of the document title cards 56a is selected, display inside the selected card 56a is changed over to additional information (such as summary, the data of issue, and so on) while an article of the selected card 56a is displayed on the detailed screen 53b. When the channel title card 56b is selected, display inside the selected card 56b is changed over to additional information (such as description, the date of issue, and so on). In each of the document title cards 56a and the channel title card 56b, the channel or document title name is displayed readably in a region not larger than a half of the area of the card 56a or 56b. Preferably, the channel or document title name written horizontally is displayed in the center and in a region not larger than a fifth of the length of the card 56a or 56b. The size of each document title card 56a is set so that the aspect ratio is in a range of from 1:3 to 3:1, preferably, 4:3. Thus, the title can be viewed easily.

The foreground and background colors in title display for the other title cards 56b than the selected title card 56b are reversed to emphasize the selected card 56b. Incidentally, the selected card 56b may be emphasized by changing the thickness, line type, color, etc. of the contour of each card 56b or by changing the color, pattern etc. of the background of each card 56b. Or the selected card 56b may be emphasized by changing the font, size, etc. of characters.

When the “Change Channel” button 57a is selected, display is changed over to a next channel (e.g. titles 1 to 8 of channel 2). When the “Next Title” button 57b is selected, display is changed over to next titles (e.g. titles 9 to 16). When the “Previous” button 57c is pushed, display is changed over to the previous article.

(Operation of Browsing System)

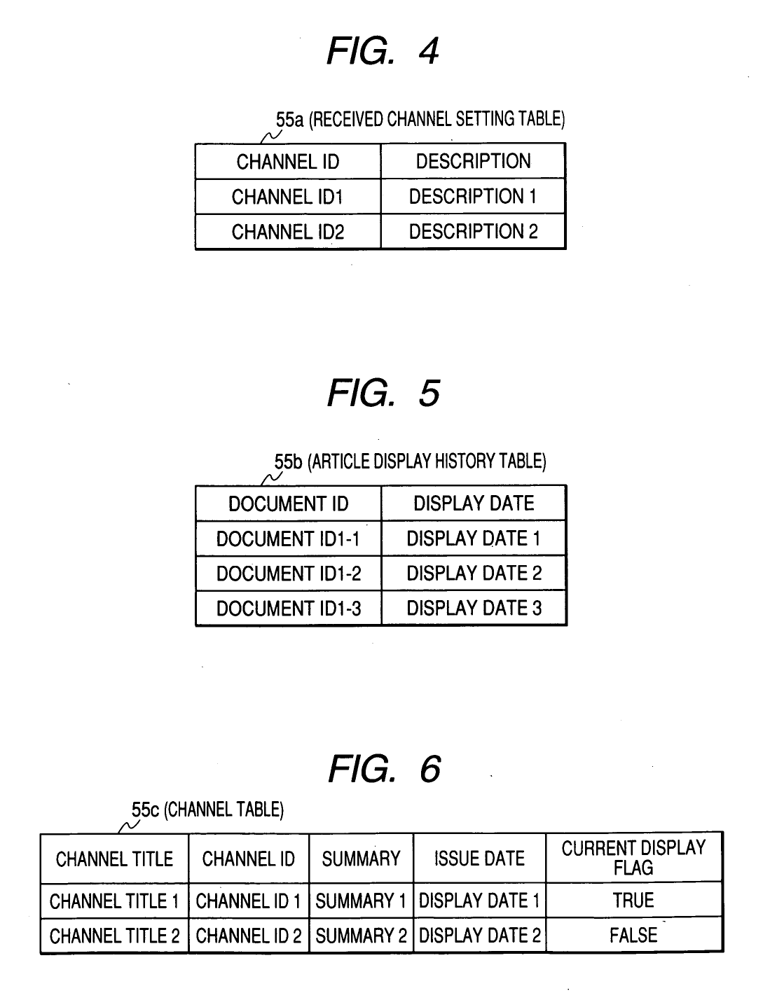

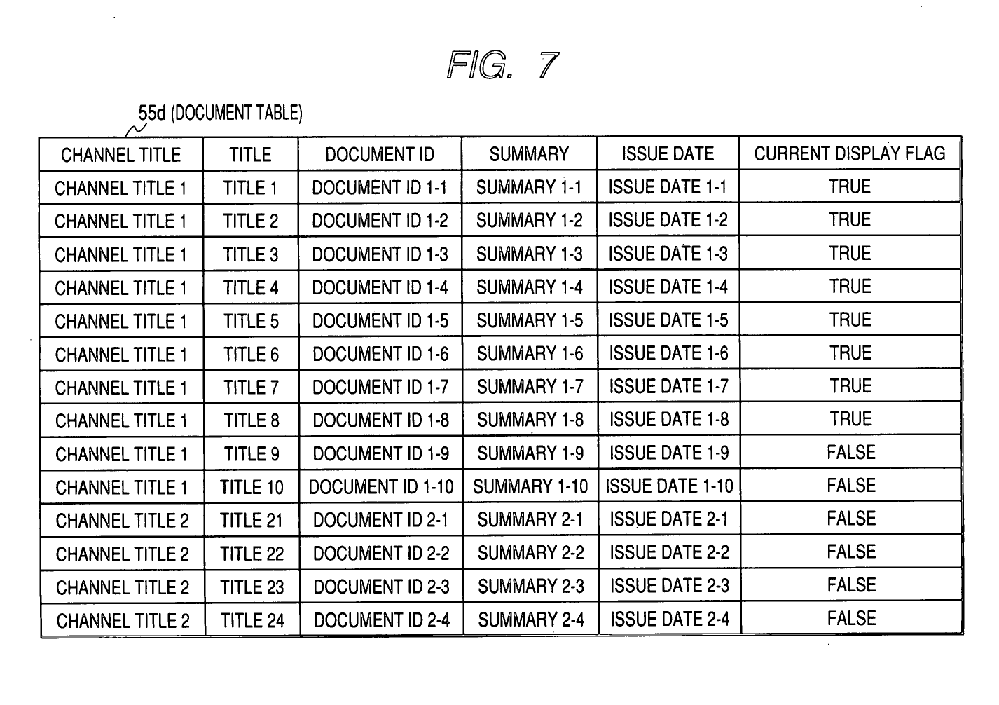

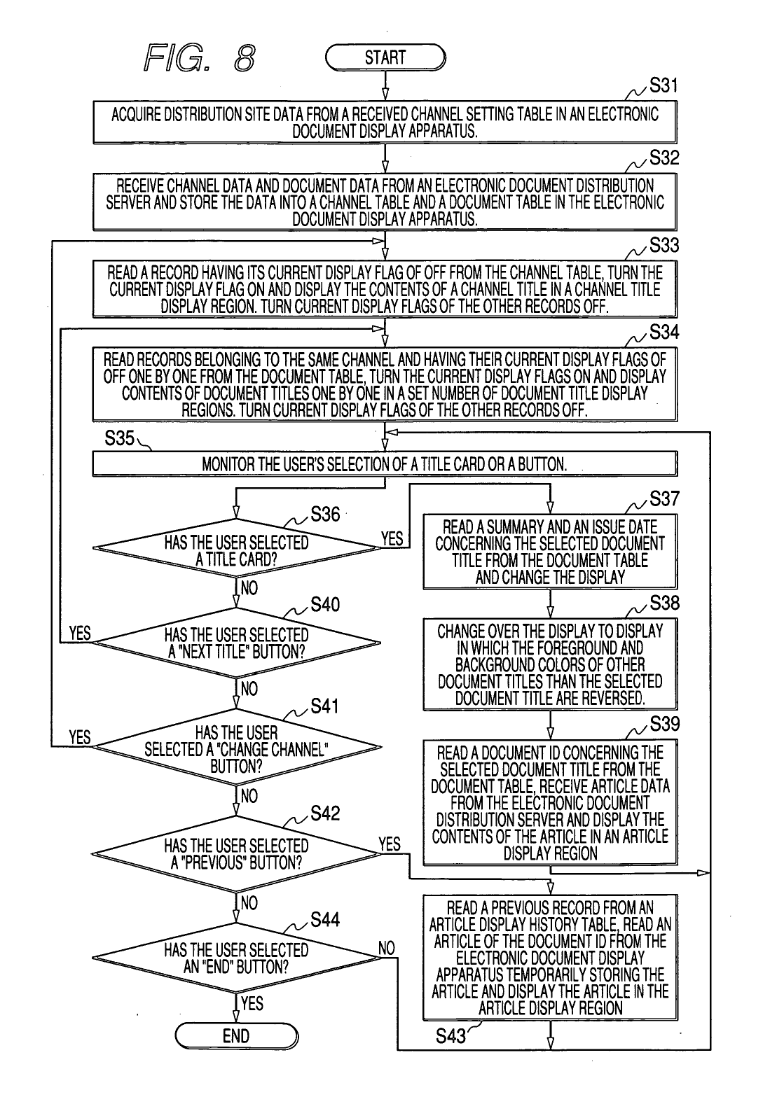

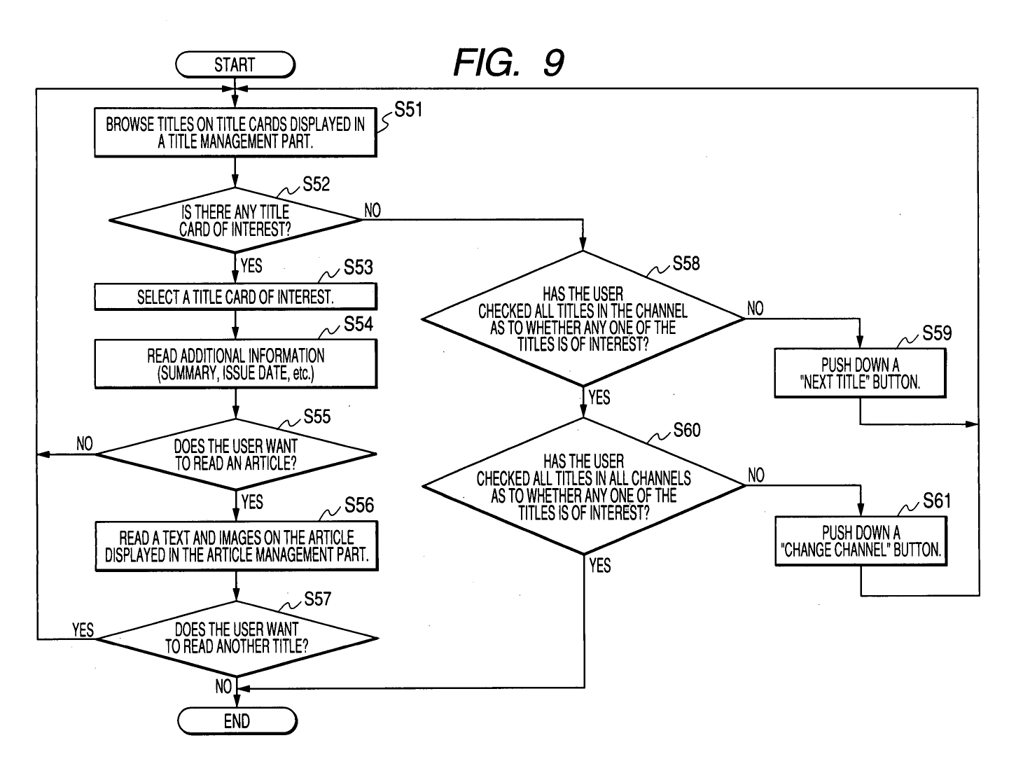

Next, an operation of the browsing system will be described with reference to FIGS. 4 to 7 in conjunction with flow charts of FIGS. 8 and 9. FIG. 4 shows a received channel setting table. FIG. 5 shows an article display history table. FIG. 6 shows a channel table. FIG. 7 shows a document table. FIG. 8 is a flow chart showing a display process on the apparatus side. FIG. 9 is a flow chart showing a procedure on the user side.

First, description will be made in accordance with the flow chart of FIG. 8 showing the display process on the apparatus side. Incidentally, in the following description, if no further specific description is made, it will be assumed that the control part 52 performs the process. When a user operates the input part 54 to issue a request to browse electronic documents, the control part 52 acquires distribution site data 58 from the received channel setting table 55a in the storage part 55 of the electronic document display apparatus 50 (S31) Successively, the control part 52 makes the communication part 51 gain access to the electronic document distribution server 20 through the network 21 on the basis of the distribution site data 58, so that channel data and document data are received from the electronic document distribution server 20 and stored in the channel table 55c and the document table 55d respectively in the storage part 55 as shown in FIGS. 6 and 7 (S32).

A record having a current display flag of OFF (False) is read from the channel table 55c shown in FIG. 6. After the current display flag is turned ON (True), the contents of a channel title are displayed in the channel title display region 56b of the selection screen 53a of the display part 53 as shown in FIG. 3 while the current display flags of the other records are turned OFF (False) (S33). Records of the same channel having current display flags of OFF (False) are one by one read from the document table 55d shown in FIG. 7. After the current display flags of the records are turned ON (True), the contents of document titles are one by one displayed in the set number of document title display regions 56a while the current display flags of the other records are turned OFF (S34). Thus, the selection screen 53a shown in FIG. 3 is displayed in the display part 53.

The control part 52 monitors the user's selection of one of the title cards 56a or the buttons 57a to 57c (S35) That is when the user selects one of the title cards 56a (S36), the summary and date of issue of the selected document title are read from the document table 55d and display is changed over to display of the summary and date of issue (S37). Then, display is changed over to display in which the foreground and background colors in display for the other document titles than the selected document title are reversed (S38) Then, the document ID of the selected document title is read from the document table 55d. Article data corresponding to the document ID is received from the electronic document distribution server 20, and the contents of the article data are displayed in the article display region 58a of the detailed screen 53b (S39).

When the user selects none of the title cards 56a in the step S36 but selects the “Next Title” button 57b (S40), the position of the process goes back to the step S34.

When the user does not select the “Next Title” button 57b in the step S40 but selects the “Change Channel” button 57a (S41), the position of the process goes back to the step S33.

When the user does not select the “Change Channel” button 57a in the step S41 but selects the “Previous” button 57c (S42), the previous record is read from the article display history table 55b and an article corresponding to the document ID is read from the storage part 55 temporarily storing the article and displayed in the article display region 58a (S43).

When the user does not select the “Previous” button 57c in the step S42 but selects an “End” button not shown (S44) the display process is terminated.

Next, description will be made in accordance with the flow chart of FIG. 9 showing the procedure on the user side. The user browses the titles inside the title cards 56a displayed on the selection screen 53a of the display part 53 (S51). When there is a title card 56a of interest (S52), the user selects the title card 56a of interest by using the input part 54 (S53). The control part 52 changes over the display inside the selected title card 56a to additional information (summary, the date of issue, and so on) and displays an article of the selected title card 56a on the detailed screen 53b. The user reads the additional information (summary, the date of issue, and so on) displayed inside the title card 56a (S54).

When the user wants to read the article further (S55), the user reads the text 58c and images 58d on the article displayed on the detailed screen 53b (S56). When the user wants to read another title (S57), the user browses again the titles inside the title cards 56a displayed on the selection screen 53a (S51).

When there is no title card 56a of interest in the step S52, the user checks whether any one of all titles in the channel is of interest or not (S58). When there is no title of interest (S59), the user pushes down the “Next Title” button 57b (S59) and browses again titles inside the title cards 56a displayed on the selection screen 53a (S51).

When there is no title of interest in the channel, the user checks whether any one of all titles in all channels is of interest or not (S60). When there is no title of interest, the user pushes down the “Change Channel” button 57a (S61) and browses again titles inside the title cards 56a displayed on the selection screen 53a (S51). When there is no title of interest in all the channels, the user's procedure is terminated.

### Effects of First Embodiment

According to the first embodiment, the following effects can be obtained.

(A) Because the whole descriptions of titles are displayed in the document title display regions (title cards) 56a, the titles can be selected easily to improve handling property for browsing.

(B) Because titles are displayed in the form of title cards 56a, the titles can be read easily to improve visibility on the browsing screen.

(C) Because the article display region is wide, visibility on the browsing screen can be improved.

Although the embodiment has been described on the case where additional information written by only characters is displayed in the selected document title display region 56a, an image (representative image) representing images 58d displayed in the article may be displayed in the selected document title display region 56a while the size of the representative image is not changed or reduced or enlarged. Thus, it becomes easy to judge whether the selected title is a subject of interest or not.

### Second Embodiment

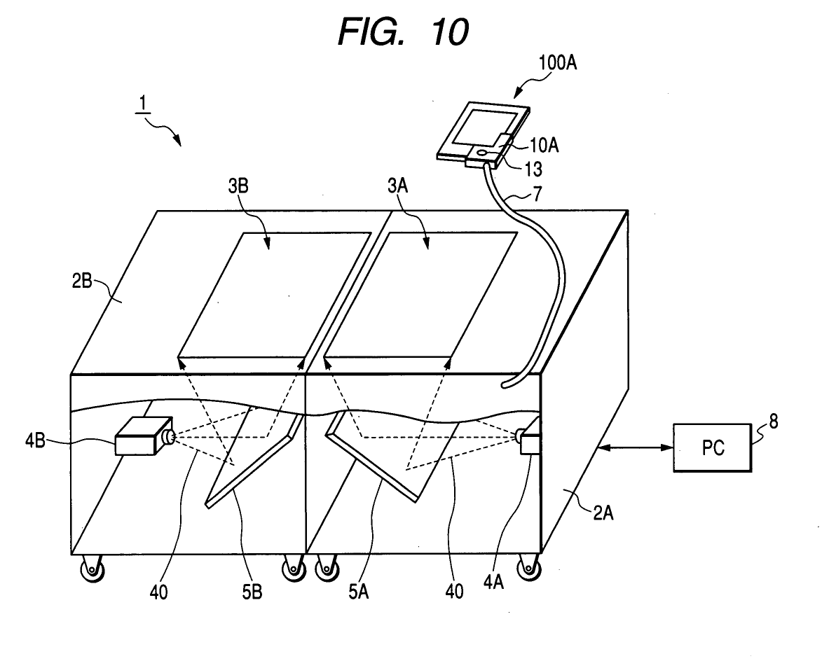

FIG. 10 is a perspective view showing an electronic paper system according to a second embodiment of the invention. This electronic paper system is configured to have light writing type electronic paper 100A acting as a display record medium and an image writing apparatus 1 for writing image information and management information about the image information into this electronic paper 100A.

Here, attribute information about a user, attribute information about the electronic paper, attribute information about an image, etc. are included in “management information”. The following information is included in these attribute information, but the management information is not limited to these classifications.

(1) An ID, a name, sex, age, an address of the user using the system, information about the presence or absence of the right to obtain contents selected, information about accounting in the case of acquiring contents selected, etc. are included in the attribute information about the user.

(2) An electronic paper ID, information about a use environment such as temperature, humidity of the electronic paper, information about a use position such as latitude, longitude, altitude of the electronic paper, information about a use history such as the number of rewritings of the electronic paper, etc. are included in the attribute information about the electronic paper.

(3) Information about a source of a written image, information about a link to a source of a written image, information about a file path in which a selected document is stored, a document ID, a book ID such as ISBN (International Standard Book Number), time for which information is browsed, place information, etc. are included in the attribute information about the image.

(Whole Configuration of Image Writing Apparatus)

The image writing apparatus 1 has two substantially box-shaped first and second cabinets 2A, 2B, first and second screen parts 3A, 3B respectively provided on upper surfaces of the cabinets 2A, 2B, first and second projectors 4A, 4B which are respectively provided inside the first and second cabinets 2A, 2B and project image light 40 on the screen parts 3A, 3B through mirrors 5A, 5B, a connector 10A which is connected to an under-mentioned controller unit provided inside the first cabinet 2A through a cable 7 and includes an operation button 13 for outputting a depression signal (writing command signal) by an operation and applies a voltage to the electronic paper 100A, and a personal computer (PC) 8 for controlling the controller unit and the projectors 4A, 4B.

Incidentally, the number of screen parts 3 (3A, 3B) is not limited to the two described above, and may be one or may be three or more. Also, the controller unit may be provided every screen part 3. Also, the connector 10A may be provided every screen part 3. A copying operation of an image can be performed efficiently by providing the connector 10A every screen part 3.

(Configuration of Light Writing Type Electronic Paper)

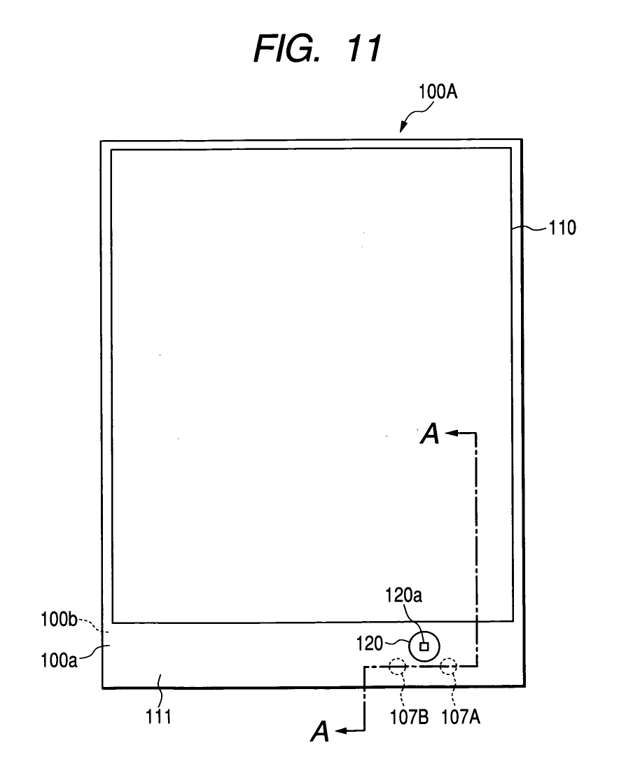

FIG. 11 is a plan view of the light writing type electronic paper 10A. This light writing type electronic paper 100A has a thin type rectangular shape, and an image display record area 110 is provided in the front 100a, and an RFID tag 120 made of an antenna (not shown) and an IC chip 120a acting as a management information record area are provided in a peripheral area 111 of the image display record area, and a pair of power receiving terminals 107A, 107B are provided in the back 100b.

Incidentally, an IC label or an IC card of a contact type may be used instead of the RFID tag 120. Also, management information may be read and written optically, magnetically or thermally according to a method for recording management information about the electronic paper into a record area.

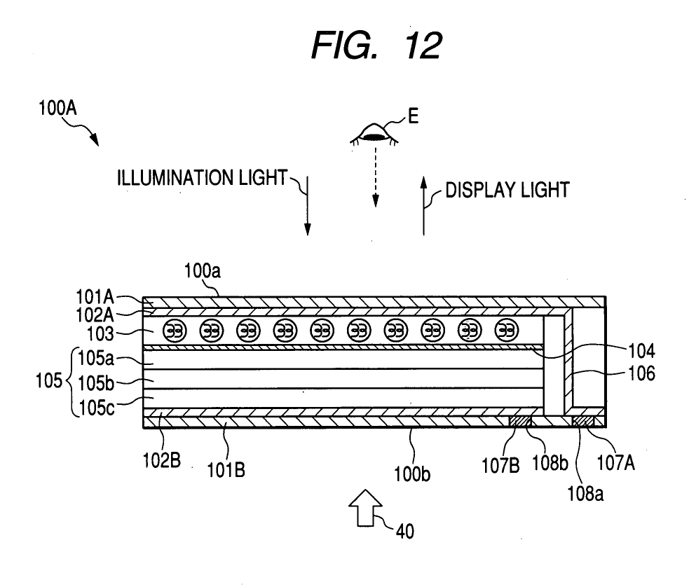

FIG. 12 is a sectional view taken on line A-A of FIG. 11. This light writing type electronic paper 100A is configured to include a pair of substrates 101A, 101B made of transparent PET (polyethylene terephthalate) films opposed and arranged, a pair of transparent electrodes 102A, 102B made of ITO (indium tin oxide) provided in the inside of these substrates, a liquid crystal layer 103 which is provided in the inside of the transparent electrode 102A of the side of the front 100a and is made of a liquid crystal having memory properties in which reflectance (transmittance) changes according to an applied voltage, for example, a cholesteric liquid crystal 103, a light absorption layer 104 provided in the inside of the liquid crystal layer 103, a photoconductive layer 105 which is provided between the light absorption layer 104 and the transparent electrode 102B of the side of the back 100b and whose resistance value reduces by irradiation with the image light 40, and an extending part 106 whose one end is connected to the transparent electrode 102A.

The cholesteric liquid crystal can adopt a configuration enclosed in a microcapsule and dispersed in a resin binder. In the case of adopting this configuration, mechanical strength increases while limiting fluidity of a display layer, so that there is an advantage that a display image resists changing with respect to stress of bending or pressure from the outside.

A pair of openings 108a, 108b are provided in the substrate 101B of the side of the back 100b and the power receiving terminal 107A is provided on the extending part 106 of one opening 108a and the power receiving terminal 107B is provided on the transparent electrode 102B of the other opening 108b.

The photoconductive layer 105 includes two electric charge generation layers 105a, 105c and an electric charge transport layer 105b provided between these layers. By adopting a configuration in which the electric charge generation layers 105a, 105c are laminated to both ends of the electric charge transport layer 105b, an AC voltage can be applied to the liquid crystal layer 103 and deterioration of the liquid crystal layer 103 can be suppressed and lowering of a driving voltage and long life of the electronic paper 100A can be achieved.

(Action of Writing into Light Writing Type Electronic Paper)

Here, an action of writing an image into the electronic paper 100A will be described. When the back 100b is irradiated with image light 40 while applying a pulse voltage between a pair of the transparent electrodes 102A, 102B through a pair of the power receiving terminals 107A, 107B, the photoconductive layer 105 is irradiated with the image light 40 through the substrate 101B and the transparent electrode 102B. In the photoconductive layer 105, a resistance value decreases by irradiation with the image light 40 and thereby a partial pressure of the liquid crystal layer 103 determined by a ratio of impedance to the photoconductive layer 105 increases and a voltage exceeding a predetermined or more threshold value is applied and thereafter it is held in a state in which light reflectance in the liquid crystal layer 103 is large.

Therefore, when the electronic paper 100A is viewed from the front 100a, an area irradiated with the image light 40 receives illumination light and is reflected by the liquid crystal layer 103 and looks white as display light. Conversely, in an area which is not irradiated with the image light 40, a resistance value of the photoconductive layer 105 increases and a voltage which does not exceed a threshold value is applied to the liquid crystal layer 103 and thereafter the liquid crystal layer 103 is held in a state of transmitting light. Since light passing through this liquid crystal layer 103 is absorbed by the light absorption layer 104, the area which is not irradiated with the image light 40 looks black.

In this electronic paper 100A, a direction of irradiation with the image light 40 is opposite to a direction of viewing an image, so that a user can check the contents of the image at once when the front 100a of the electronic paper 100A is viewed from a direction of E without reversing the electronic paper 100A.

(Configuration of Connector)

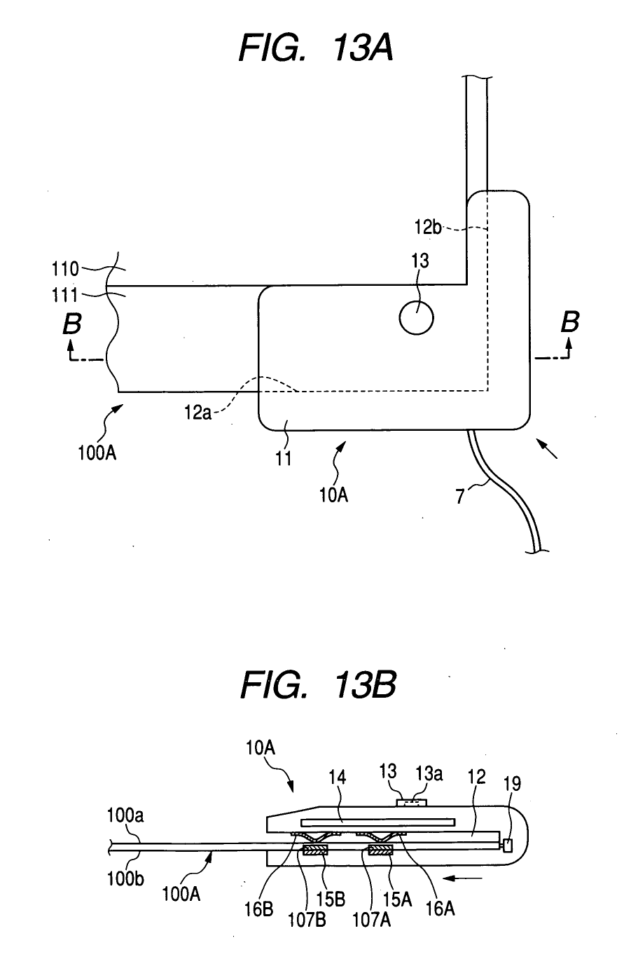

FIG. 13 shows the connector 10A and FIG. 13A is a plan view and FIG. 13B is a sectional view taken on line B-B of FIG. 13A. This connector 10A includes a substantially U-shaped case 11, an attachment opening 12 having abutment surfaces 12a, 12b of the electronic paper 10A, an operation button 13 which is provided protrudably from a surface of the case 11 and wherein an LED lamp 13a for emitting green light is buried in the surface side, a reader/writer 14 for reading and writing management information with respect to the IC chip 120a of the RFID tag 120, power feeding terminals 15A, 15B which are exposed to the attachment opening 12 and apply a pulse voltage to the power receiving terminals 107A, 107B of the electronic paper 100A attached to the attachment opening 12, and pressure springs 16A, 16B which are provided in positions opposed to the power feeding terminals 15A, 15B of the attachment opening 12 and press the electronic paper 100A attached to the attachment opening 12 to the sides of the power feeding terminals 15A, 15B, and in the case of attaching the connector 10A to the electronic paper 00A, the connector 10A is attached in a direction shown by an arrow of FIG. 13. At this time, when the electronic paper 100A is inserted to a predetermined abutment place of the inside of the connector 10A, it is configured so as to turn on the LED lamp 13a inside the operation button 13 described above when a lever of a limit switch 19 provided in an abutment position presses the end of the electronic paper 100A to shift to an ON state of the switch. By adopting this configuration, it is constructed so as to be able to check at a glance that a position between electrode terminals of the connector 10A and the electronic paper 100A is proper before a voltage is applied to the electronic paper 100A.

(Control System of Electronic Paper System)

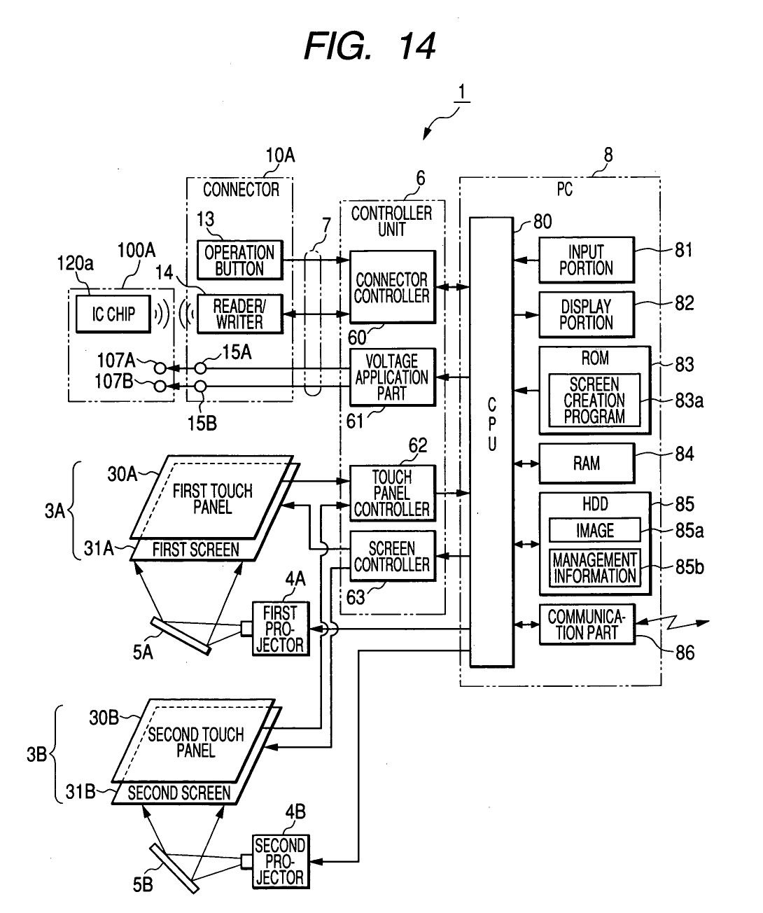

FIG. 14 is a block diagram showing a control system of the electronic paper system. In this electronic paper system, a controller unit 6 and the projectors 4A, 4B are connected to the PC 8, and the screen parts 3A, 3B and the connector 10A are connected to the controller unit 6. The operation button 13, the reader/writer 14 and the power feeding terminals 15A, 15B of the connector 10A are connected to the controller unit 6 through the cable 7 as described above.

(Configuration of Screen Part)

As shown in FIG. 14, the first screen part 3A is configured by laminating a first transparent touch panel 30A and a first screen 31A and is arranged so that the first touch panel 30A is located to the front side. In a manner similar to the first screen part 3A, the second screen part 3B is also configured by laminating a second transparent touch panel 30B and a second screen 31B and is arranged so that the second touch panel 30B is located to the front side.

In the first and second touch panels 30A, 30B, for example, a resistance film method (pressure sensitive method) is used, but an electromagnetic induction method, an electrostatic coupling method, an ultrasonic surface acoustic wave method, an infrared shielding method, etc. may be used.

The first and second screens 31A, 31B are in a light scattering state when a voltage is not applied, and shift to a light transmission state by application of a voltage, and a film (for example, Um Film manufactured by Nippon Sheet Glass Um Product Co., Ltd.) in which a nematic liquid crystal layer is dispersed into a polymer in drop shape and this is sandwiched between a pair of film substrates having a transparent electrode can be used.

(Configuration of Controller Unit)

The controller unit 6 includes a connector controller 60 for accepting a depression signal from the operation button 13 of the connector 10A and also sending and receiving management information between the reader/writer 14 and the connector controller, a voltage application part 61 for applying a pulse voltage to the power receiving terminals 107A, 107B of the electronic paper 100A through the power feeding terminals 15A, 15B, a touch panel controller 62 for inputting coordinate positions of the first and second touch panels 30A, 30B, and a screen controller 63 for switching the first and second screens 31A, 31B between a light scattering state and a light transmission state.

(Configuration of PC)

The PC 8 has a CPU 80 for controlling the whole electronic paper system and the inside of the PC 8, and an input part 81 such as a keyboard or a mouse, a display part 82 such as a liquid crystal display, ROM 83 for storing action programs such as a screen creation program 83a of the CPU 80, RAM 84 for temporarily storing data, an HDD 85 for storing an image 85a and management information 85b, etc. and a communication part 86 for communicating with a PC or a server of the outside on the Internet or a LAN (Local Area Network) are connected to this CPU 80.

(Action of Electronic Paper System)

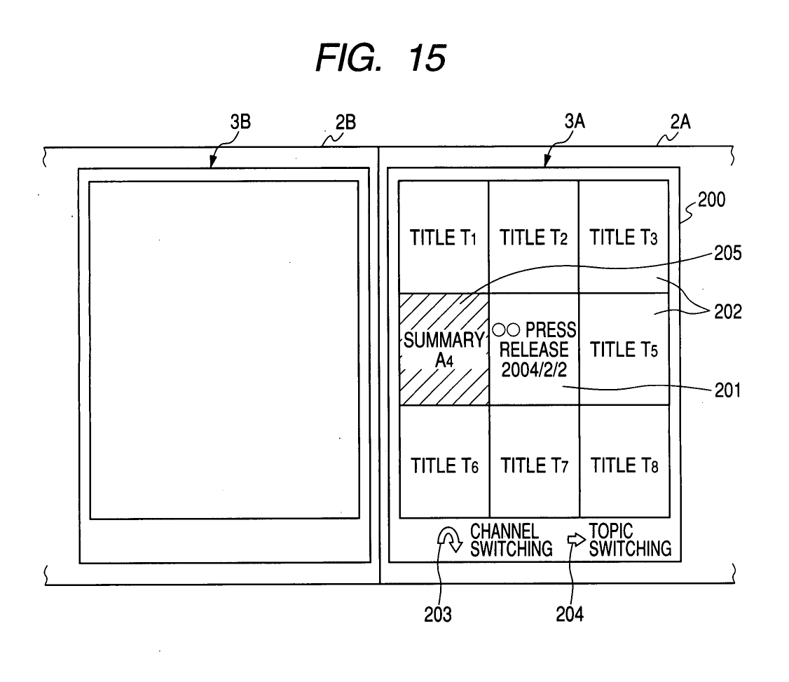

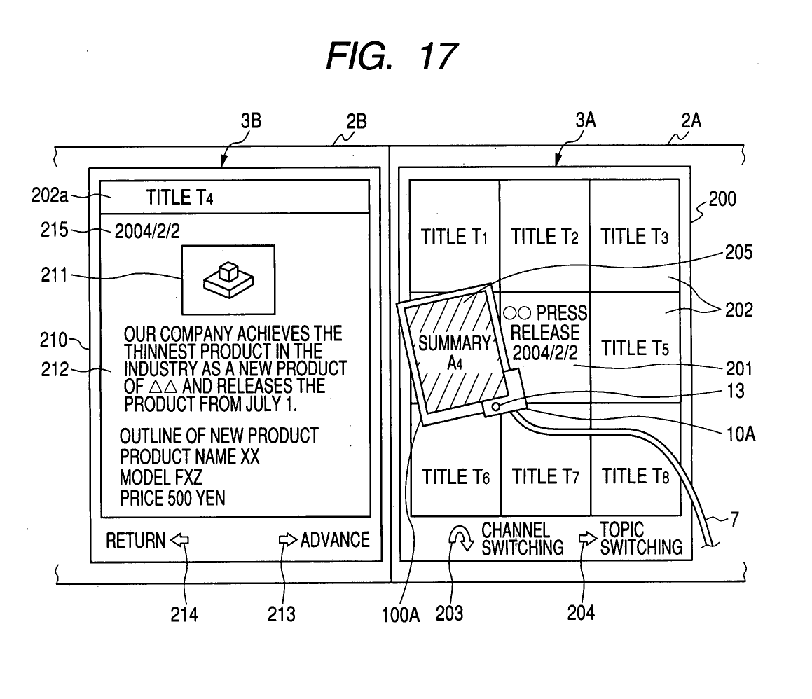

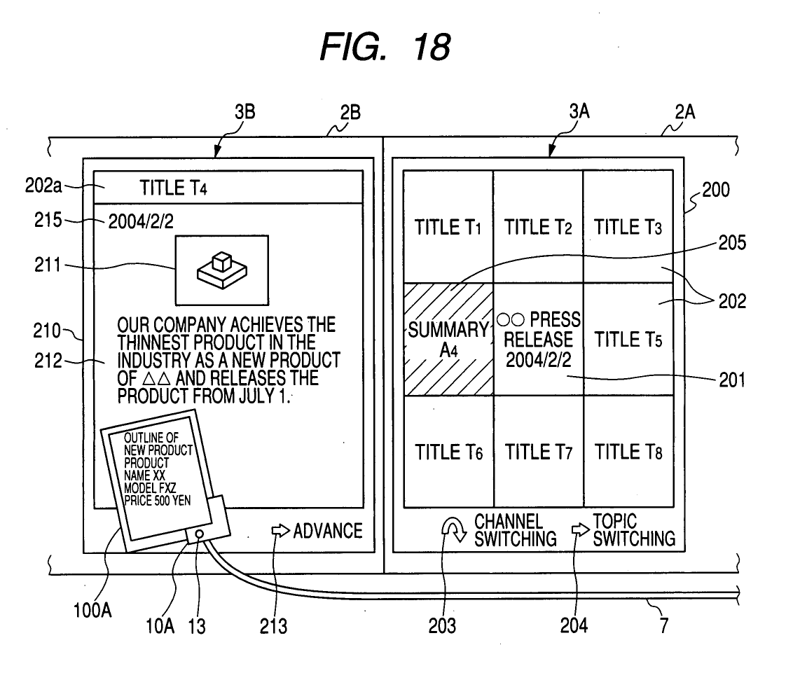

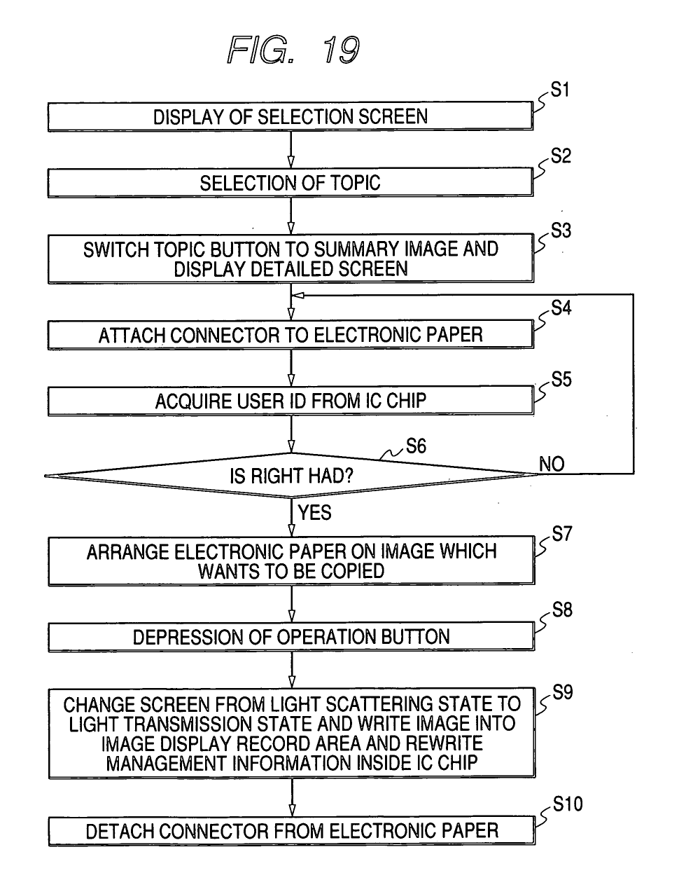

Next, an action of the electronic paper system will be described according to a flowchart of FIG. 19 with reference to FIGS. 15 to 18 showing a display example of the screen parts 3A, 3B.

When a power source of the image writing apparatus 1 is turned on, the CPU 80 of the PC 8 reads a selection screen out of the HDD 85 and sends its image signal to the first projector 4A. The first projector 4A projects image light of the selection screen on the first screen part 3A through the mirror 5A based on the image signal from the CPU 80 (S1).

FIG. 15 shows one example of the selection screen displayed on the first screen part 3A. On this selection screen 200, a channel display image 201 is displayed in the center as shown by “◯◯ press release” and in the periphery of the channel display image, eight topic buttons 202 having the size substantially equal to that of the image display record area 110 of the electronic paper 100A and displaying titles T1 to T8 are displayed in matrix shape and a channel switching key 203 and a topic switching key 204 are displayed in the lower side.

In this stage, a voltage is not applied to the first screen 31A of the first screen part 3A and the first screen 31A is in a light scattering state and the selection screen 200 projected on the first screen 31A can be viewed through the first touch panel 30A at a wide viewing angle. Also, the channel display image 201 and the topic buttons 202 are constructed so as not to be bright by blackening a background color and whitening a character color even when the whole surface of the first screen 31A is in a light transmission state.

The channel switching key 203 is means in which the contents of display switch from a channel displayed at present to another channel when this channel switching key is depressed by a finger, and the topic switching key 204 displays another topic button belonging to the channel displayed at present when this topic switching key is depressed by a finger.

It is assumed that a user touches one topic button 202 (for example, a hatched portion in FIG. 15) among the selection screen 200 and selects a title T4 (S2).

The touch panel controller 62 sends the coordinate information to the CPU 80. Based on the coordinate information sent from the touch panel controller 62, the CPU 80 reads a summary image 205 of a summary A4 corresponding to the title T4 and a detailed screen out of the HDD 85, and creates a screen in which the summary image 205 of the summary A4 is fitted instead of the topic button 202 of the title T4 on the RAM 84 based on the screen creation program 83a, and projects the image light 40 on the first screen 31A from the first projector 4A. Subsequently, the CPU 80 projects image light 40 of the detailed screen on the second screen part 3B from the second projector 4B (S3).

FIG. 16 shows one example of a detailed screen displayed on the second screen part 3B and a selection screen displayed on the first screen part 3A. Details of news are displayed in this detailed screen 210 using a topic image 202a of a title T4, an image 211, text 212, a date 215, etc. In a summary image 205 selected and displayed, a background color is whitened and a character color is blackened in a manner similar to normal paper. Here, when another topic button 202 is depressed, its topic button 202 switches to a corresponding summary image 205 and the second screen part 3B shifts to a detailed screen corresponding to it. At this time, the summary image 205 displayed until then may be returned to the topic button 202.

When a user copies an image among screens projected on the first and second screen parts 3A, 3B to the electronic paper 100A, the electronic paper 100A is attached to the attachment opening 12 of the connector 10A (S4) and the sides of a short side and a long side of the electronic paper 100A are respectively abutted on the abutment surfaces 12a, 12b of the attachment opening 12 as shown in FIG. 10 and FIG. 13A. When the electronic paper 100A is arranged in a predetermined abutment position, the limit switch 19 is turned on and the LED lamp 13a buried in the operation button 13 illuminates green. In this state, the power feeding terminals 15A, 15B of the connector 10A are in contact with the power receiving terminals 107A, 107B of the electronic paper 100A.

The reader/writer 14 of the connector 10A performs continuous reading actions for detecting a unique ID of the IC chip 120a adjacent always by a control signal from the connector controller 60 based on control of the CPU 80. By inserting the electronic paper 100A into the connector 10A, the unique ID (can also be called a user ID of an owner) of the IC chip 120a inside the electronic paper 100A is read as a part of management information (S5) and the acquired unique ID (user ID) is sent to the CPU 80 through the connector controller 60. The CPU 80 retrieves the management information 85b stored in the HDD 85 using the user ID as a retrieval key, and decides whether or not the user is a person having the right to obtain contents information (S6). In the case that the user does not have the right, even when the operation button 13 of the connector 10A is depressed, no change occurs and the flowchart does not proceed to processing subsequent to step S9. In this case, it waits for timing for reading the unique ID (user ID) of the IC chip in which use of the contents information is permitted again (S4).

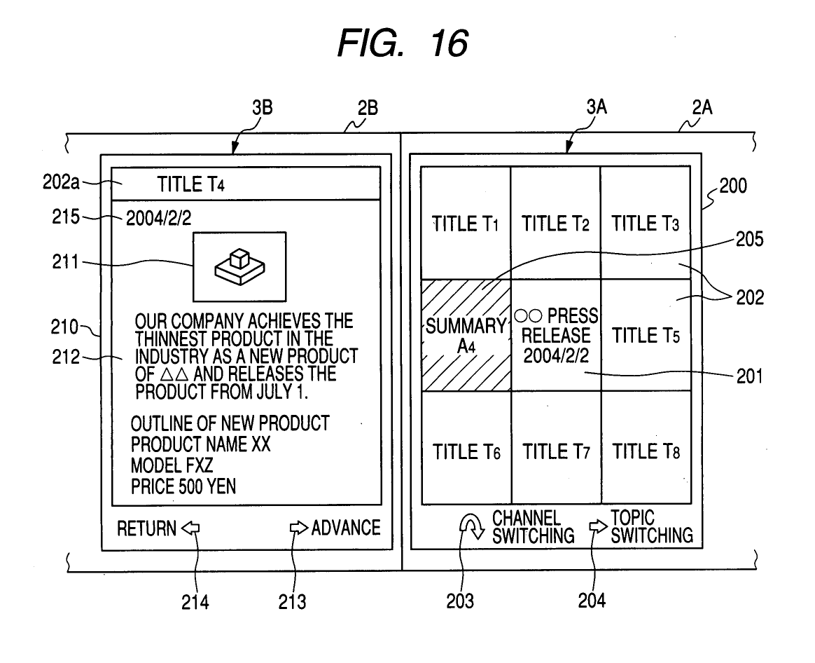

In the case that the user has the right in step S6, the electronic paper 100A is arranged on an image which wants to be copied. For example, the electronic paper 100A attached to the connector 10A is brought close to a place which wants to be copied among images displayed on the screen part 3 and is arranged as shown in FIG. 17 when the summary image 205 wants to be copied or as shown in FIG. 18 when a part of the detailed screen 210 wants to be copied (S7).

Next, the user depresses the operation button 13 of the connector 10A (S8). Its depression signal is sent to the CPU 80 of the PC 8 through the cable 7 and the controller unit 6. The screen controller 63 switches the first and second screens 31A, 31B from a light scattering state to a light transmission state (S9).

Subsequent to this, the CPU 80 applies a pulse voltage to the power receiving terminals 107A, 107B of the electronic paper 100A through the power feeding terminals 15A, 15B of the connector 10A by the voltage application part 61. As a result of this, an image is written into the image display record area 110 of the electronic paper 100A as described above. In parallel with this, the CPU 80 sends updating information for updating accounting information recorded into the IC chip 120a and source information (for example, a URL (Uniform Resource Locator)) about an image written into the electronic paper 100A to the reader/writer 14. The reader/writer 14 updates the accounting information inside the IC chip 120a and also writes the URL into the IC chip 120a (S9).

When rewriting of the image and rewriting of the management information are completed, the user detaches the electronic paper 100A from the connector 10A (S10). The image written into the electronic paper 100A continues to be displayed over the long term even without a power source, and the management information written into the IC chip 120a is provided for management of the user, the electronic paper 100A, the image, etc.

Incidentally, particularly when it is unnecessary to impose limitations on a user using contents, there can naturally be the case of proceeding to actions subsequent to S9 at the time of depressing the operation button 13 without reading the unique ID (or a user ID of an owner) on the electronic paper 100A inserted into the connector 10A among the flowchart described above and collating the unique ID with a list of the inside of the PC 8.

Incidentally, if the size of the image display record area of the electronic paper 100A is bigger than a size twice as big as the size of the topic button, an image of the topic button next to the topic button, whose image is the target of copying will be copied along with the target image and the management information are mixedly stored. To avoid this failure, the image display record area of the electronic paper 100A is preferably configured smaller than the size twice as big as the size of the topic button.

### Effects of Second Embodiment

The following effects can be obtained according to this second embodiment.

(A) Rewriting of an image and rewriting of management information are performed by one operation of the operation button 13, so that the operation becomes simple and easy.

(B) A URL of an image written into the electronic paper 100A is written into the IC chip 120a, so that the URL recorded into the IC chip 120a can be read out to invoke a corresponding image on a screen again by holding the electronic paper 100A to which an image is copied over a reader/writer for URL reading even when screen information projected on the first screen part 3A or the second screen part 3B changes to another contents or is deleted due to a lapse of time, etc. As a result of this, even for transient information temporarily displayed on the screen, utilization and sharing of information can be promoted at intervals by using the electronic paper.

(C) Since the projector 4 with a deep focal depth is used as a display, it is unnecessary to bring the electronic paper 100A into intimate contact with a screen, so that dirt or a flaw of the electronic paper 100A can be reduced and an electronic paper system with ease of use can be provided.

(D) Management information is read and written with respect to the electronic paper 10A by noncontact, so that there is no problem of wear etc. in a connection terminal and long life can be achieved.

(E) Management information is read and written from a place close to an RFID tag, so that power in a signal of sending and receiving is not required too much and also a situation in which noise breaks into the signal reduces and reliability of reading and writing of the management information improves.

### Third Embodiment

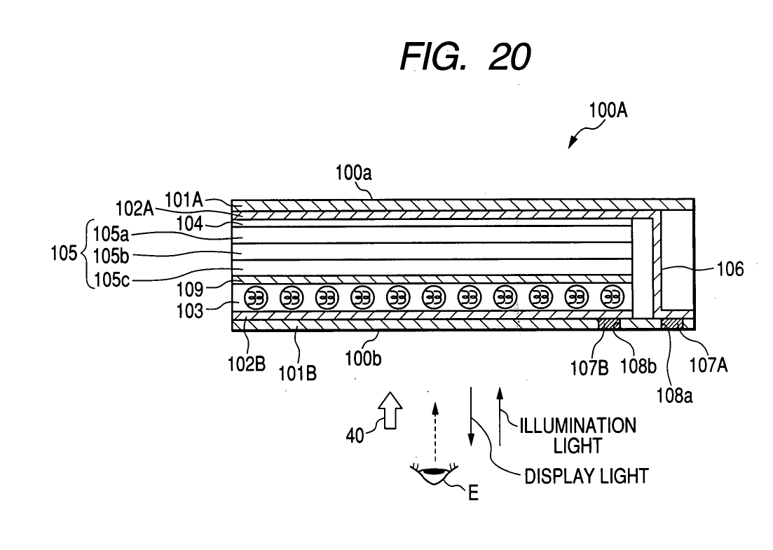

FIG. 20 shows electronic paper according to a third embodiment of the invention. Electronic paper 100A shown in FIG. 20 is means of a light writing type and in the configuration of FIG. 12, it is configured so that arrangement of a liquid crystal layer 103 and a photoconductive layer 105 is replaced and also an isolation layer 109 is provided between the liquid crystal layer 103 and a light absorption layer 104 and further the light absorption layer 104 is disposed inside a transparent electrode 102A. According to this, an image is written on a principle similar to that of the electronic paper 100A described above and the photoconductive layer 105 is irradiated with image light 40 through a substrate 101B, the liquid crystal layer 103 and the isolation layer 109 and a viewing direction becomes equal to a direction of irradiation with the image light 40. Therefore, it is unnecessary to transmit light to the front 100a, so that display information in arrangement in which the electronic paper 100A is attached to a wall etc. can be rewritten and use can be made as a display surface of advertisement or design.

### Fourth Embodiment

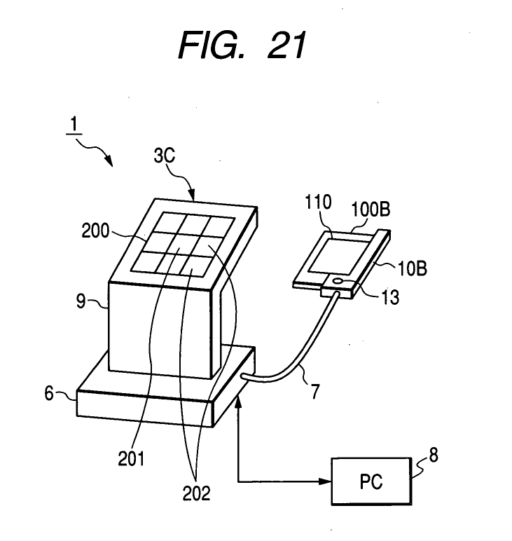

FIG. 21 is a perspective view showing an electronic paper system according to a fourth embodiment of the invention. This electronic paper system is configured to have self-writing type electronic paper 100B acting as a display record medium and an image writing apparatus 1 for writing image information and management information about the image information into this electronic paper 100B.

The image writing apparatus 1 is configured to have a stand 9 having a screen part 3C, a controller unit 6 arranged in a lower portion of the stand 9, a connector 10B for supplying a power source to the self-writing type electronic paper 100B through a cable 7 and a PC 8 connected to the controller unit 6.

The self-writing type electronic paper 100B is constructed so that an image display record area 110 is configured by sandwiching a display material having memory properties by plural X electrodes and plural Y electrodes and passive matrix driving is performed by an X driver and a Y driver described below, and an RFID tag is provided in a record area of management information in a manner similar to the second embodiment. Incidentally, the self-writing type electronic paper 100B may be constructed so that the image display record area 110 is configured by sandwiching a display material having memory properties by a total electrode and plural pixel electrodes and active driving is performed using a TFT driving element etc. or driving is performed by a segment electrode divided into plural display areas.

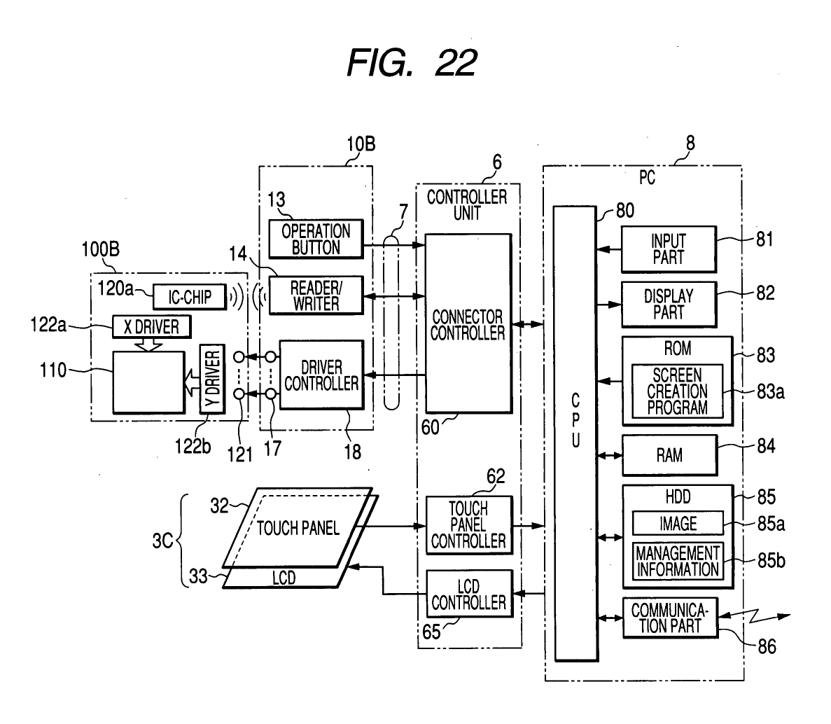

FIG. 22 is a block diagram showing a control system of the electronic paper system according to this fourth embodiment. In this electronic paper system, the controller unit 6 is connected to the PC 8, and the screen part 3C and the connector 10B are connected to the controller unit 6.

(Configuration of Connector)

The connector 10B is means in which a driver controller 18 is added and an output terminal corresponding to an input terminal of the electronic paper 100B is provided with respect to the connector 10A of the second embodiment, and the other is configured in a manner similar to the second embodiment. The driver controller 18 is means for generating a data signal, a control signal, a driving voltage, etc. supplied to an X driver 122a and a Y driver 122b of the electronic paper 100B. Incidentally, the driver controller 18 may be provided in the controller unit 6 in order to miniaturize the connector 10B.

(Configuration of Screen Part)

The screen part 3C is configured by laminating a transparent touch panel 32 and an LCD 33 and is arranged so that the touch panel 32 is located to the front side. In a manner similar to the second embodiment, a resistance film method (pressure sensitive method) is used in the touch panel 32, but an electromagnetic induction method, an electrostatic coupling method, an ultrasonic surface acoustic wave method, an infrared shielding method, etc. may be used. Also, a simple matrix type LCD is used in the LCD 33 and a touch panel function may be provided in this LCD to detect coordinates by an electrostatic coupling method. As a result of this, there is no need to provide a touch panel separately, so that the screen part can be thinned.

(Configuration of Controller Unit)

The controller unit 6 of this fourth embodiment includes a connector controller 60 for accepting a depression signal from an operation button 13 of the connector 10B and also sending and receiving management information between a reader/writer 14 and the connector controller and outputting a necessary control signal to the driver controller 18, a touch panel controller 62 for inputting a coordinate position of the touch panel 32, and an LCD controller 65 for performing display control of the LCD 33.

(Action of Electronic Paper System)

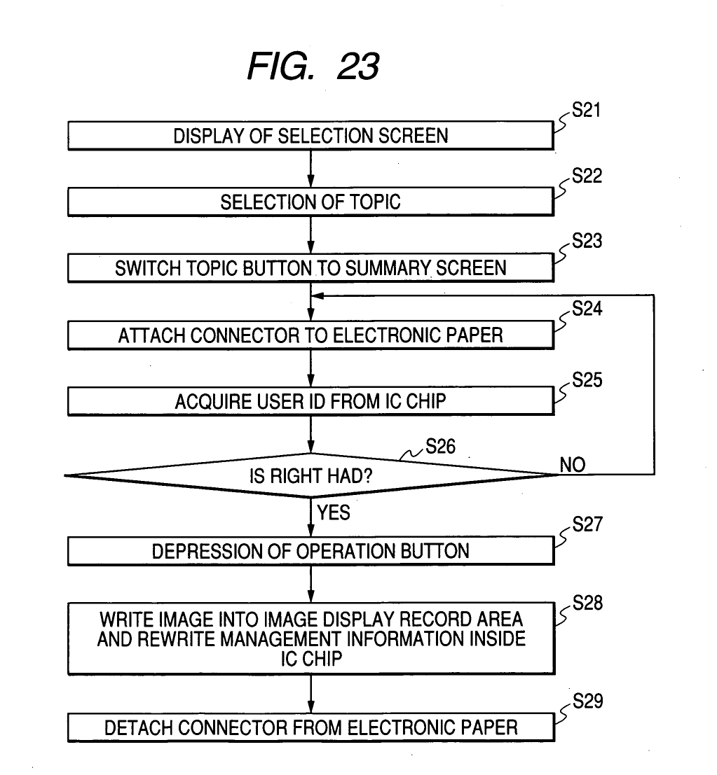

Next, an action of the electronic paper system will be described according to a flowchart of FIG. 23. When a power source is turned on, a selection screen similar to that of the second embodiment is displayed on the screen part 3C by control of the PC 8 (S21). That is, on this selection screen 200, a channel display image 201 is displayed in the center and in the periphery of the channel display image, eight topic buttons 202 having the size substantially equal to that of the image display record area 110 of the electronic paper 100B and displaying titles are displayed in matrix shape and a channel switching key and a topic switching key are displayed in the lower side.

When a user touches one topic button 202 among the selection screen 200 and selects a title (S22), the touch panel controller 62 sends the coordinate information to a CPU 80. Based on the coordinate information sent from the touch panel controller 62, the CPU 80 reads a summary image corresponding to the selected title and a detailed screen out of an HDD 85, and creates a screen in which the summary image is fitted instead of the topic button 202 on RAM 84 based on a screen creation program 83a, and displays its image on the LCD 33 by the LCD controller 65 (S23).

When the user wants to copy the summary image displayed on the screen part 3C to the electronic paper 100B, the electronic paper 100B is attached to an attachment opening of the connector 10B (S24). In this state, an output terminal 17 of the connector 10B is in contact with an input terminal 121 of the electronic paper 100B.

The reader/writer 14 of the connector 10B acquires management information including a user ID from an IC chip 120a of the electronic paper 100B (S25) and sends the management information to the CPU 80. The CPU 80 retrieves management information 85b stored in the HDD 85 using the user ID as a retrieval key, and decides whether or not the user is a person having the right to obtain contents information (S26). In the case that the user does not have the right, even when subsequent depression of the operation button 13 is executed (S27), the flowchart again returns to S24 without performing processing subsequent to step S28 and it waits for the user having the contents information to insert the electronic paper 100B into the connector 10B.

In the case that the user has the right to obtain the contents information in step S26, by depression of the operation button 13 of the connector 10B (S25), its depression signal is sent to the CPU 80 of the PC 8 through the cable 7 and the controller unit 6.

Thereafter, the driver controller 18 supplies a data signal, a control signal and a driving voltage, etc. to the X driver 122a and the Y driver 122b through the output terminal 17 and the input terminal 121 under control of the CPU 80. The X driver 122a and the Y driver 122b write an image into the image display record area 110 by performing passive driving of an X electrode and a Y electrode. In parallel with this, the CPU 80 sends updating information for updating accounting information recorded into the IC chip 120a and source information (for example, a URL) about an image written into the electronic paper 100B to the reader/writer 14. The reader/writer 14 updates the accounting information inside the IC chip 120a and also writes the URL into the IC chip 120a (S28).

When rewriting of the image and rewriting of the management information are completed, the user detaches the electronic paper 100B from the connector 10B (S29). The image written into the electronic paper 100B continues to be displayed over the long term even without a power source, and the management information written into the IC chip 120a is provided for management of the user, the electronic paper 100B, the image, etc.

Incidentally, particularly when it is unnecessary to impose limitations on a user using contents, there can naturally be the case of proceeding to actions subsequent to S28 at the time of depressing the operation button 13 without reading a unique ID (or a user ID of an owner) on the electronic paper 100B inserted into the connector 10B among the flowchart described above and collating the unique ID with a list of the inside of the PC 8.

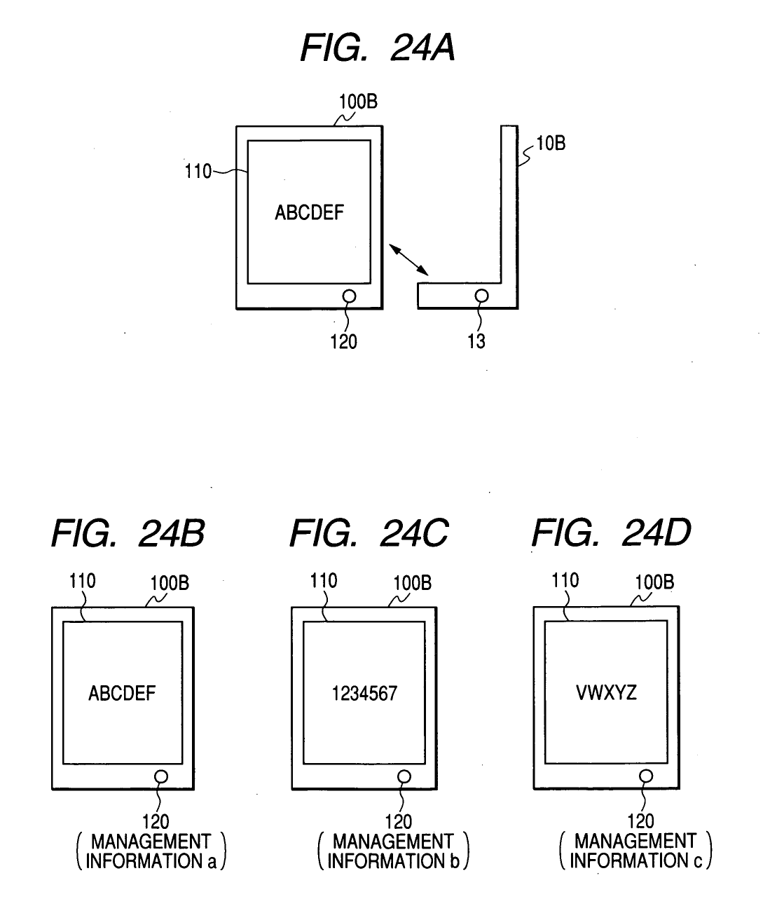

FIG. 24 is a view showing use forms of the electronic paper system according to the fourth embodiment. The connector 10B can be attached to and detached from the electronic paper 100B as shown in FIG. 24A, so that as shown in FIGS. 24B to 24D, an image may be written into the image display record area of the electronic paper 100B to record management information a to c different corresponding to this into the IC chip.

### Effect of Fourth Embodiment

The following effects can be obtained according to this fourth embodiment.

(A) Rewriting of an image and rewriting of management information are performed by one operation of the operation button 13, so that the operation becomes simple and easy in a manner similar to the second embodiment.

(B) A URL of an image written into the electronic paper 100B is written into an IC chip, so that the corresponding image can be acquired by reading out the URL recorded into the IC chip by a reader/writer even when an image on the electronic paper 100B is deleted.

Next, a connector according to a fifth embodiment of the invention will be described. This fifth embodiment is provided with a communication part for receiving an image and management information from the outside by wire or wireless independently of a PC, memory in which the received image information and management information are stored, a controller in which an image writing signal is outputted to the output terminal 17 and the input terminal 121 based on the image information stored in the memory by depression of the operation button 13 and an IC chip of the electronic paper 100B is rewritten by the reader/writer 14 based on the management information stored in the memory and a battery for supplying electric power to each the part of the connector and the X driver and the Y driver of the electronic paper 100B in the fourth embodiment. By providing a function equivalent to that of the image writing apparatus for the connector thus, the system can be miniaturized.

### Sixth Embodiment

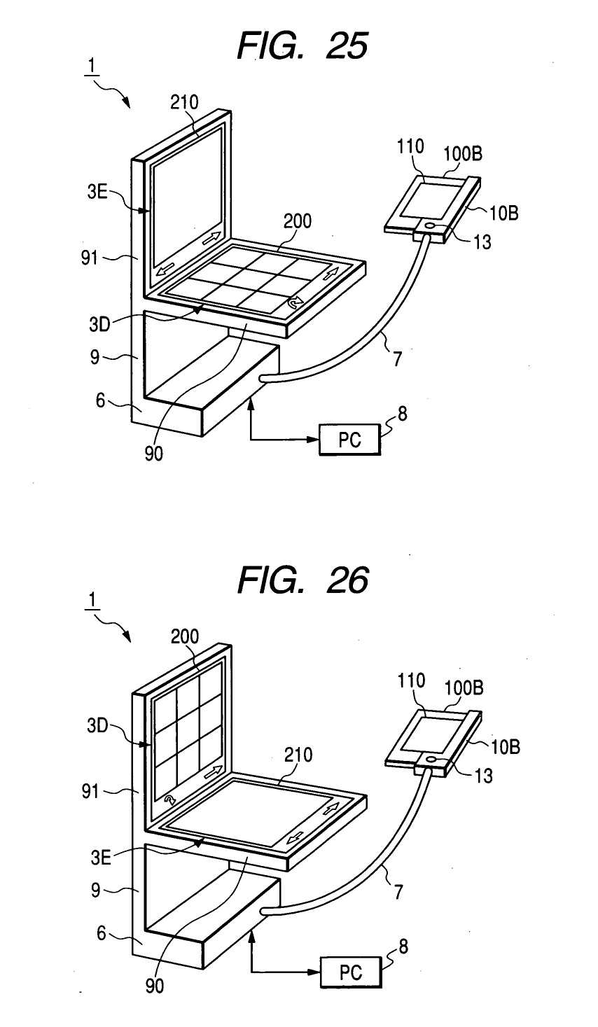

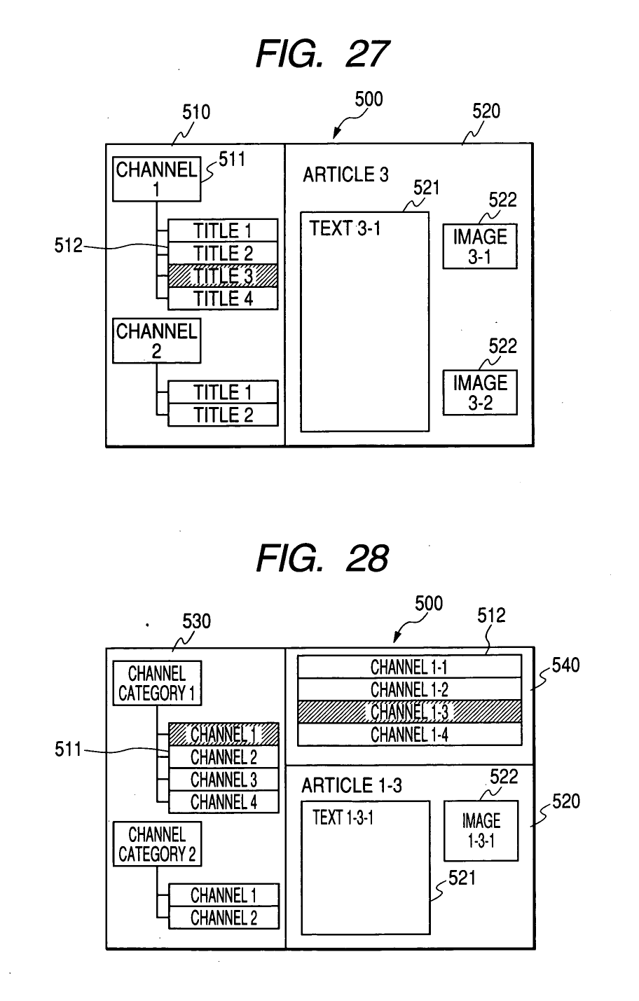

FIG. 25 is a perspective view showing an electronic paper system according to a sixth embodiment of the invention. The sixth embodiment is formed in the same manner as in the fourth embodiment shown in FIG. 21 except that a horizontal support part 90 for supporting a first screen part 3D and a vertical support part 91 for supporting a second screen part 3E are provided in the stand 9.

Each of the first and second screen parts 3D and 3E is formed as a transparent laminate of a touch panel and an LCD in the same manner as in the fourth embodiment. In each screen part, the touch panel and the LCD are provided so that the touch panel is disposed on the front surface side. The sixth embodiment is configured so that a selection screen 200 is displayed in the first screen part 3D while a detailed screen 210 is displayed in the second screen part 3E.

According to the sixth embodiment, details of contents selected on the selection screen 200 near the user's hand are displayed on the detailed screen 210 in front of the user. Accordingly, excellent handling property and visibility can be obtained.

### Seventh Embodiment

FIG. 26 is a perspective view showing an electronic paper system according to a seventh embodiment of the invention. The seventh embodiment is formed in the same manner as in the sixth embodiment, except that the first screen part 3D is provided in the vertical support part 91 while the second screen part 3E is provided in the horizontal support part 90. According to this configuration, details of contents selected on the selection screen 200 in front of the user are displayed on the detailed screen 210 near the user's hand. Accordingly, it is easy to copy a required image from the detailed screen 210 to the sheet of electronic paper 100B.

### Other Embodiments

Incidentally, the invention is not limited to each the embodiment described above and various modifications can be made without departing from the subject matter. For example, components between each of the embodiments can be combined arbitrarily.

Also, by writing various information as management information, it can be applied to various systems without being limited to the system described above.

Also, in the embodiment described above, an image writing signal from the connector to the display record medium is sent by bringing a terminal of the connector side into contact with a terminal of the medium side, but the signal may be sent by noncontact by making connection optically, magnetically or thermally.

Also, in addition to the display record medium described above, a heat-sensitive record medium using leuco dye, a liquid crystal having memory properties typified by a ferroelectric liquid crystal, other display record media of an electrophoretic method for switching display by moving charged particles in liquid, a toner display method for switching display by moving charged particles in air, a particle rotation method for switching display by rotating charged particles, a magnetic migration method for switching display by moving particles by magnetism, etc. may be used as a display record medium having memory properties.

Also, in the second embodiment, the projector is used as a display apparatus, but instead of the projector, by a projector in which a display apparatus such as a CRT display or a plasma display is combined with an image formation optical system, image light from the display apparatus may be formed in the image display record area of the electronic paper.

Also, instead of the projector, a CRT display or a flat display such as an LCD (liquid crystal display), an ELD (electroluminescent display), a PDP (plasma display), a VFD (vacuum fluorescent display), an LED (light emitting diode) display, an FED (field emission display) maybe used as a display apparatus to bring the electronic paper into intimate contact with an image display surface.

Also, management information maybe written into a display record medium by the same means as means for writing an image. For example, it is contemplated to write the management information into the image display record area 110. As a result of this, the need for a device (such as a reader/writer) dedicated to reading and writing of the management information is eliminated and a configuration can be simplified.

Also, a memory card into which management information is written is provided detachably in the electronic paper and the memory card into which the management information is written may be inserted into a slot of an external device of a PC etc. to read the management information out of the memory card. As a result of this, usability of the management information increases.

In addition, an IC card of a non-contact type detachably provided in the electronic paper may be used instead of providing an IC chip in the electronic paper as described in the above embodiments.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. A browsing apparatus comprising:
a screen part that displays a plurality of card-like selection buttons indicating identification data for identifying subjects of retrieval;
a selection receiving part that receives a selection of one of the selection buttons; and
a display control part that displays one of the subjects of retrieval corresponding to the selected selection button in the screen part.

2. The browsing apparatus according to claim 1, wherein
the subjects of retrieval are electronic documents; and
the identification data are at least one of titles of the electronic documents and images as representative ones of the images contained in the electronic documents.

3. The browsing apparatus according to claim 1, wherein each of the identification data is displayed readably in a region less than a half of a display area of the selection buttons.

4. The browsing apparatus according to claim 1, wherein each of the selection buttons is shaped like a rectangle having an aspect ratio in a range of 1:3 to 3:1.

5. The browsing apparatus according to claim 1, wherein the plurality of selection buttons displayed in the screen part are arranged in a form of a lattice.

6. The browsing apparatus according to claim 1, wherein the display control part displays at least one of a title, summary and date of distribution of the subject of retrieval corresponding to the selected selection button in the selected selection button along with or in place of the identification data.

7. The browsing apparatus according to claim 1, wherein the display control part displays the selected subject of retrieval in a region or window different from the region or window where the selection buttons are displayed.

8. The browsing apparatus according to claim 1, wherein the display control part displays the selected selection button or contents displayed in the selected selection button in a mode different from a mode in which the non-selected selection buttons or contents displayed in the non-selected selection buttons are displayed.

9. The browsing apparatus according to claim 1, wherein the display control part divides a display screen of the screen part into two screen parts, displays the plurality of selection buttons in one screen part and displays the selected subject of retrieval in the other screen part.

10. The browsing apparatus according to claim 1, wherein the selection receiving part is a transparent touch panel which is disposed on the screen part.

11. The browsing apparatus according to claim 1, further comprising:
a display record medium capable of rewriting information and visibly displaying the information, wherein
the display record medium is detachably attached to the browsing apparatus, and
the display record medium is configured to be a rectangular shape, and
a size of a display record area of the display record medium is bigger than a size of the selection button and is smaller than a size twice as big as the size of the selection button.

12. A browsing method comprising the steps of:
displaying a plurality of card-like selection buttons indicating identification data for identifying subjects of retrieval in a screen part;
receiving a selection of one selection button from the plurality of selection buttons; and
displaying one of subjects of retrieval corresponding to the selected selection button in the screen part.

13. The browsing method according to claim 12, wherein
the subjects of retrieval are electronic documents; and the identification data are at least one of titles of the electronic documents and images as representative ones of the images contained in the electronic documents.

14. The browsing method according to claim 12, wherein each of the identification data is displayed readably in a region less than a half of a display area of the selection buttons.

15. The browsing method according to claim 12, wherein each of the selection buttons is shaped like a rectangle having an aspect ratio in a range of 1:3 to 3:1.

16. The browsing method according to claim 12, wherein the plurality of selection buttons displayed in the screen part are arranged in a form of a lattice.

17. The browsing method according to claim 12, further comprising the step of:
displaying at least one of a title, summary and date of distribution of the subject of retrieval corresponding to the selected selection button in the selected selection button along with or in place of the identification data.

18. The browsing method according to claim 12, further comprising the step of:
displaying the selected subject of retrieval in a region or window different from the region or window where the selection buttons are displayed.

19. The browsing method according to claim 12, further comprising the step of:
displaying the selected selection button or contents displayed in the selected selection button in a mode different from a mode in which the non-selected selection buttons or contents displayed in the non-selected selection buttons are displayed.

20. The browsing method according to claim 12, further comprising the steps of:
dividing a display screen of the screen part into two screen parts;
displaying the plurality of selection buttons in one screen part; and
displaying the selected subject of retrieval in the other screen part.
